(19) United States
(12) Patent Application Publication
(10) Pub. No.: US 2008/0088975 A1
(43) Pub. Date: Apr. 17, 2008

(54) METHOD FOR FORMING AN ELECTRICAL INTERCONNECT TO A SPRING LAYER IN AN INTEGRATED LEAD SUSPENSION

(75) Inventors: Jeffry S. Bennin, Hutchinson, MN (US); Reid C. Danielson, Cokato, MN (US); Galen D. Houk, Hutchinson, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Hutchinson Technology Incorporated, Hutchinson, MN (US)

(21) Appl. No.: 11/876,320

(22) Filed: Oct. 22, 2007

Related U.S. Application Data
(62) Division of application No. 10/794,681, filed on Mar. 5, 2004, now Pat. No. 7,337,529.

(51) Int. Cl. G11B 15/64

(52) U.S. Cl. 360/234.5

(57) ABSTRACT

A method for forming an electrical interconnect to the spring metal layer in an integrated lead suspension or suspension component of the type having a multi-layer structure including a spring metal layer and a conductor layer separated by a dielectric insulator layer. The method includes forming an aperture through at least one of either the spring metal and conductor layers, and optionally through the dielectric layer, at an interconnect site. A first mass of malleable conductive metal is inserted into the aperture. The mass of metal is then coined to form a stud that engages at least the spring metal layer at the interconnect site.

### FIELD OF THE INVENTION

This invention relates generally to integrated lead suspensions of the type used in magnetic disk drives or other dynamic data storage systems. More particularly, this invention relates to the forming of electrical interconnects in integrated lead suspension components formed as a multilayer structure, such as a laminate, including a stainless steel layer and a conductor layer separated by a dielectric insulator layer.

### BACKGROUND OF THE INVENTION

Integrated lead suspensions for supporting a read/write head over a rotating disk in a magnetic data storage device are in widespread use and are well known. Such suspensions include a load beam (typically formed from a spring material such as stainless steel), a flexure (also typically formed from stainless steel) at a distal end of the load beam, conductors (also known as traces or leads and typically formed from copper), and a dielectric insulator layer between the conductor and adjacent stainless steel layers. Such an integrated lead suspension can be constructed from a multilayer structure such as a laminated sheet of material comprising a stainless steel layer and the conductive layer bonded together by the dielectric insulator layer. The integrated lead suspension can be formed by a subtractive process such as a photolithographic chemical and plasma etching processes. Typically, the integrated lead suspension comprises a so-called integrated lead flexure that is formed from the laminate material, and a separate load beam formed from stainless steel. The integrated lead flexure is welded or otherwise attached to the load beam. A slider carrying the read/write head is mounted to the flexure. The leads electrically connect the read/write head to electronic circuitry in the disk drive. The read/write head is electrically connected to the flexure leads by means of slider bond pads which electrically connect to the lead termination pads on the flexure.

Typically, there is an electrical ground connection between the conductive traces and the stainless steel layer of the flexure. Known grounding structures and approaches include plated lead structures that are isolated from adjacent read/write trace and pad structures. The ground connection is typically placed in a central location along the head slider centerline at a “fifth pad” location. Use of such a fifth pad of electroplated conductor material in the gimbal region of the integrated lead suspension for grounding requires plating buss lines (usually accomplished by joining a ground trace or feature to adjacent read/write traces) that must be removed to isolate the ground feature after the plating process. This requires a process for creating an isolated conductive island which is separate from the plating circuit. The island typically is electroplated with gold, a relatively low-corrosion material, to avoid exposed copper, a relatively corrosive material, in the gimbal area. Another option is to use a separate but detabbed plating buss leaving exposed copper. Either method can result in increased cost, process complexity, and decreased reliability. Therefore, there can be a need for a copper lead grounding structure that does not require additional photolithographic steps or result in exposed copper in the gimbal area.

It also can be desirable that the ground feature have the same height as the read/write pads in the gimbal, promoting easier, more efficient head termination in integrated lead suspensions.

There also can be a need for a ground interconnect between the stainless steel layer and the conductive layer of an integrated lead suspension comprised of a laminate of stainless steel, dielectric, and conductive traces. Known approaches for creating this ground interconnect include either using a conductive adhesive material between the stainless steel layer and the conductive layer or using a plated ground feature. The conductive adhesive has a higher resistance than is desirable and is prone to contamination. Use of a plated ground feature adds process steps and cost to the integrated lead suspension. Neither of these methods results in a ground feature that is flush with both the stainless steel and conductive layer surfaces.

Therefore, there can be a need for an improved ground connection between the stainless steel layer and the conductive layer of an integrated lead suspension formed from a laminate comprising a stainless steel layer, a dielectric layer, and a conductive layer. The improved ground connection should have low resistance, defeat the chromium oxide surface that forms on the stainless steel layer, and utilize an affordable and robust manufacturing process.

### SUMMARY OF THE INVENTION

The present invention is a high-quality interconnect that can be incorporated into integrated lead suspensions on suspension components.

### BRIEF DESCRIPTION OF THE DRAWINGS

FIG. 1 is a perspective view of a portion of an integrated lead flexure and slider showing the coined ground pad in accordance with the present invention in the fifth pad location.

FIG. 2 is a detailed sectional view of a portion of the integrated lead flexure and coined ground pad shown in FIG. 1.

FIG. 3 is a sectional view of the portion of the integrated lead flexure shown in FIG. 2 prior to etching of the through hole in the stainless steel during formation of the coined ground pad shown in FIGS. 1 and 2.

FIG. 4 is a sectional view of the portion of the integrated lead flexure shown in FIG. 3 after a through hole has been etched in the stainless steel during formation of the coined ground pad shown in FIGS. 1 and 2.

FIG. 5 is a sectional view of the portion of the etched integrated lead flexure shown in FIG. 4 showing a mass of malleable conductive metal on an ultrasonic ball bonding tip prior to insertion into the etched through hole during formation of the coined ground pad shown in FIGS. 1 and 2.

FIG. 6 is a sectional view of the portion of the etched integrated lead flexure shown in FIG. 5 after the mass of malleable conductive metal has been inserted into the etched through hole during formation of the coined ground pad shown in FIGS. 1 and 2.

FIG. 7 is a sectional view of the coining step being performed on the mass of malleable conductive metal of FIG. 6 during formation of the coined ground pad shown in FIGS. 1 and 2.

FIG. 8 is a sectional view showing the coined first mass of malleable conductive metal in the integrated lead flexure following the steps illustrated in FIGS. 6 and 7 and showing a second mass of malleable conductive metal on a ball bonding tip prior to its application to the first mass of malleable conductive metal during formation of the coined ground pad shown in FIGS. 1 and 2.

FIG. 9 is a sectional view of the integrated lead flexure of FIG. 8 after the second mass of metal has been applied to the coined ground feature during formation of the coined ground pad shown in FIGS. 1 and 2.

FIG. 10 is a sectional view of the coining step being performed on the second mass of malleable conductive metal of FIG. 9 during formation of the coined ground pad shown in FIGS. 1 and 2.

FIG. 11 is a sectional view of an alternative embodiment of a coined stud ground pad in accordance with the present invention.

FIG. 12 is a sectional view of another alternative embodiment of a coined ground pad in accordance with the present invention.

FIGS. 13(a) and 13(b) are sectional views illustrating the formation of another alternative embodiment of the coined stud ground pad in accordance with the present invention.

FIG. 14 is a perspective view of an integrated lead flexure showing the stud ground of the present invention as a ground connection between the stainless steel layer and the conductive layer of the integrated lead flexure.

FIG. 15 is a detailed sectional view of the stud ground and integrated lead flexure of FIG. 14.

FIG. 16 is a detailed sectional view of the integrated lead flexure of FIG. 14 showing the mass of malleable conductive metal after it has been inserted into the through hole during formation of the stud ground.

FIG. 17 is a detailed sectional view of the coining step being performed on the mass of malleable conductive metal during the formation of the stud ground shown in FIG. 15.

FIG. 18 is a detailed sectional view of an alternative embodiment of the stud ground in accordance with the present invention.

FIG. 19 is a detailed sectional view of the stud ground in accordance with another embodiment of the present invention inserted into a via.

FIG. 20 is a detailed sectional view of a stud attachment in accordance with another embodiment of the present invention.

FIG. 21 is a detailed sectional view showing the alignment of the through holes of the three-layer flex circuit and suspension component during the formation of the stud attachment shown in FIG. 20.

FIG. 22 is a sectional view showing the mass of malleable conductive metal during the formation of the stud attachment shown in FIG. 21.

FIG. 23 shows an alternative embodiment of a stud attachment in accordance with the present invention.

### DETAILED DESCRIPTION OF THE PREFERRED EMBODIMENT

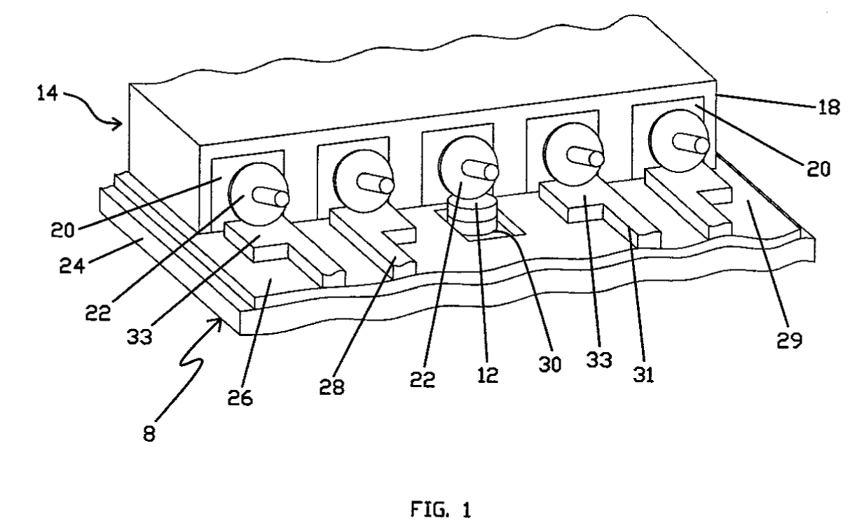

FIG. 1 is an illustration of a portion of the “lead” or “copper” side of a wireless or integrated lead flexure 8 (i.e., a suspension component) including a coined stud ground pad 12 in accordance with a first embodiment of the present invention. The flexure 8 is formed from multilayer structure. The multilayer structure may be formed through an additive process (e.g. deposition) or a subtractive process (e.g. etching) or some combination of additive and subtractive processes. In one embodiment, the flexure 8 may be formed from a laminated sheet of material. The flexure 8 includes a stainless steel layer 24 (i.e., spring metal layer) and a conductive metal or trace layer 28 separated by a dielectric insulator layer 26. The stainless steel layer 24 (a conductive material) is etched or formed into structural portions such as tongue 29 and side spring arms (not shown). The trace layer 28, which is often copper or copper alloy, is formed into a number of integrated traces or leads 31. Leads 31 terminate at the end of the tongue 29 at bond pads 33. Portions of the dielectric layer 26 are also removed, but generally remain at locations where the leads 31 overlay the stainless steel layer 24. Flexures such as 8 (with the exception of stud ground pad 12) are generally known and commercially available from a number of manufacturers including Hutchinson Technology Incorporated of Hutchinson, Minn. In preferred embodiments the flexure 8 is manufactured from a laminated sheet of material using conventional or otherwise known photolithography and etching processes. However, the studs and other interconnects in accordance with the invention can be incorporated into other types of suspensions and suspension components, including those manufactured by other processes.

A conventional head slider 18 is mounted to the tongue 29 of the flexure 8 shown in FIG. 1. A read/write head (not shown) on the slider 18 is electrically interconnected to the leads 31 of the flexure 8 at slider pads 20. As shown, the slider pads 20 are positioned adjacent to associated lead bond pads 33. Conventional termination ball bonds 22 electrically interconnect the associated slider pads 20 and lead bond pads 33. In the embodiment shown, the coined stud ground pad 12 is centrally located between slider pads 20 on the flexure 8.

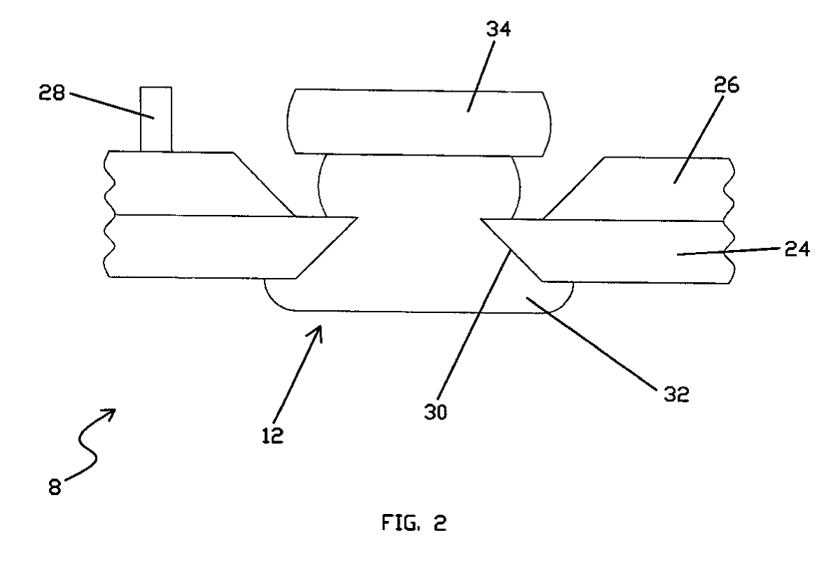

FIG. 2 is a detailed sectional view of a portion of the integrated lead flexure 8 shown in FIG. 1 with coined ground pad 12 (i.e., an interconnect) in accordance with the present invention. Coined ground pad 12 is comprised of at least a first mass of malleable conductive metal 32 in an aperture or through hole 30 in the flexure 8. As shown, pad 12 may also include at least one additional mass of malleable conductive metal 34. The height of coined ground pad 12 is equal to the height of the associated conductive trace layer 28 in the illustrated embodiment.

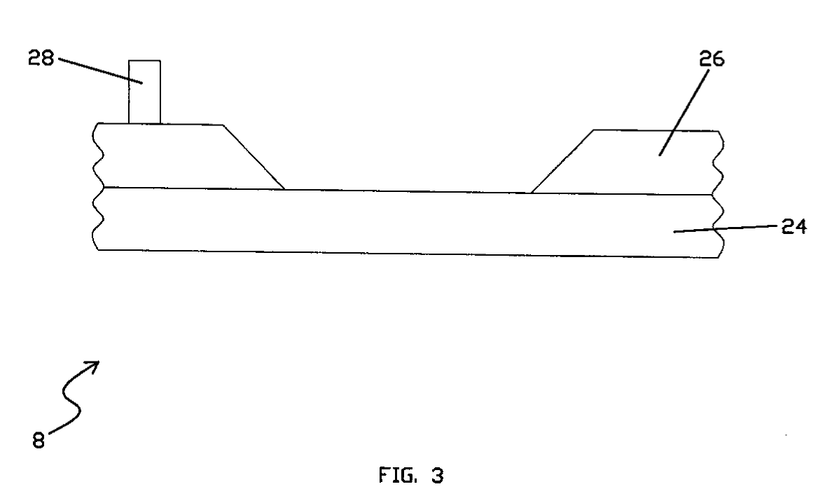

FIG. 3 is a detailed sectional view of a portion of the integrated lead flexure 8 shown in FIGS. 1 and 2 prior to etching of through hole 30 in the stainless steel layer 24 of integrated lead flexure 8. In the embodiment shown in FIG. 3, the portion of the dielectric layer 26 at the site of ground pad 12 has already been removed.

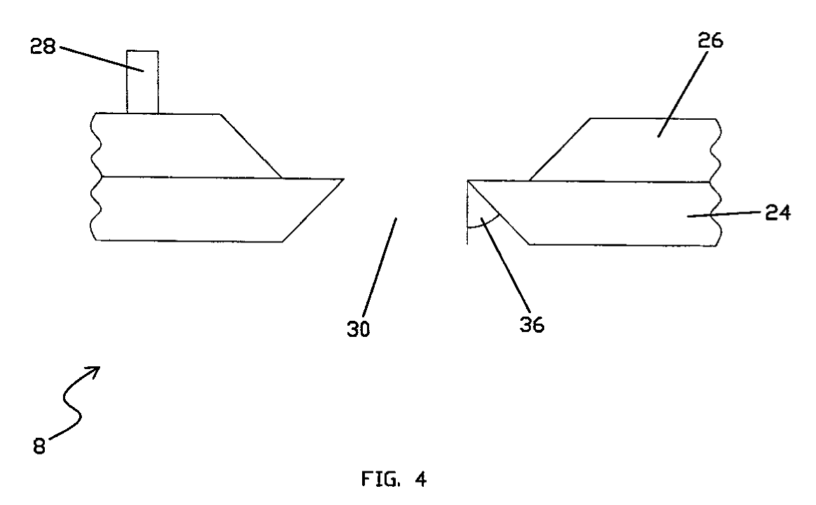

FIG. 4 is a sectional view of the portion of integrated lead flexure 8 of FIG. 3 after through hole 30 has been etched into stainless steel layer 24 using a photolithographic etching process. Through hole 30 in stainless steel layer 24 has a diameter 0.05 to 0.250 mm in one embodiment, and is sized for reliable etch clear-out in volume production as well as an interference fit for a first mass of malleable conductive metal 32. Through hole 30 will typically have an angle 36 due to the etching process. In some embodiments the angle can be between 5 to 20 degrees. Through hole 30 can be etched, machined, stamped, laser cut, laser burned or applied in any other reasonable manner as known in the art. Through hole 30 can be modified from a circular hole to a rectangle, triangle, or other shape to enhance the bonding performance of the coined ground pad 12 to the stainless steel layer 24.

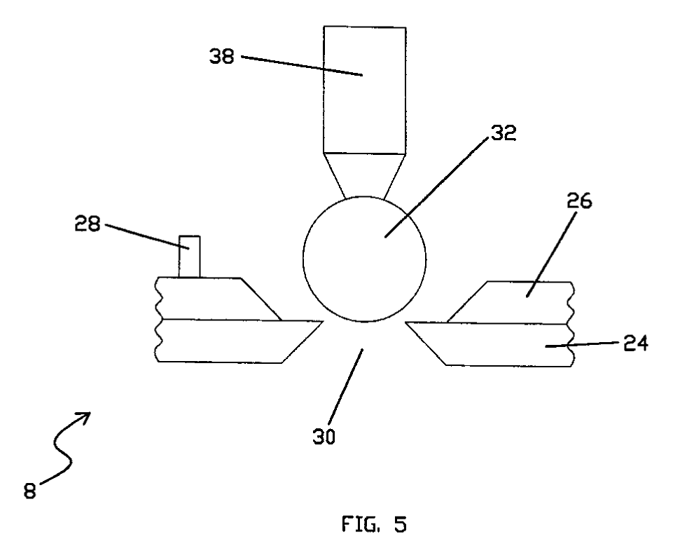

FIG. 5 shows the integrated lead flexure 8 and first mass of malleable conductive metal 32 positioned for insertion on ceramic ultrasonic ball bonding ultrasonic tip 38 as is commonly known in the wire ball bond or ball stitch industry. The first mass of metal 32 is pressed into through hole 30 by the ceramic ultrasonic ball bonding tip 38, setting an initial anchor or joint between the mass 32 and the stainless steel layer 24. First mass of malleable conductive metal 32 can be gold, a gold alloy as typically used in the wire ball bond or ball stitch termination industry, or another material or alloy such as aluminum, brass, or some other conductive material. In one embodiment of the invention the first mass of malleable conductive metal 32 is comprised of gold wire (e.g., 0.012 to 0.075 mm diameter) which is formulated into a flamed off gold ball (e.g., about 0.075 to 0.125 mm diameter). The wire diameter and gold ball diameter can vary as needed.

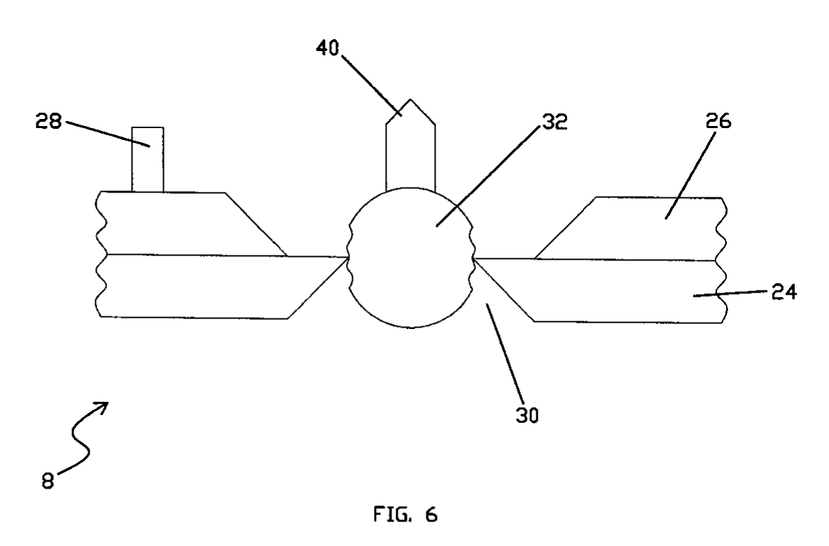

FIG. 6 shows the portion of the integrated lead flexure 8 after the mass of malleable conductive metal 32 has been inserted into through hole 30. The mass of malleable conductive metal 32 protrudes through the through hole 30 in stainless steel layer 24. Remaining wire material tail 40 is also shown. When forming the mass 32 from the wire (not shown), typically a tensile force is used to elongate and break the wire, which results in a tensile force on the mass of malleable conductive metal 32 and wire tail 40. Alternatively, gold ball stitch equipment that cuts off or removes the wire tail 40 from an applied gold ball could be used. If ball stitch equipment is used that cuts off or removes the wire tail 40, the machine severs the wire with minimal force, eliminating the tensile force and aiding in retention of the mass of malleable conductive metal 32. This can help promote stacking of masses of malleable conductive metal without concern of the interference of wire tail 40.

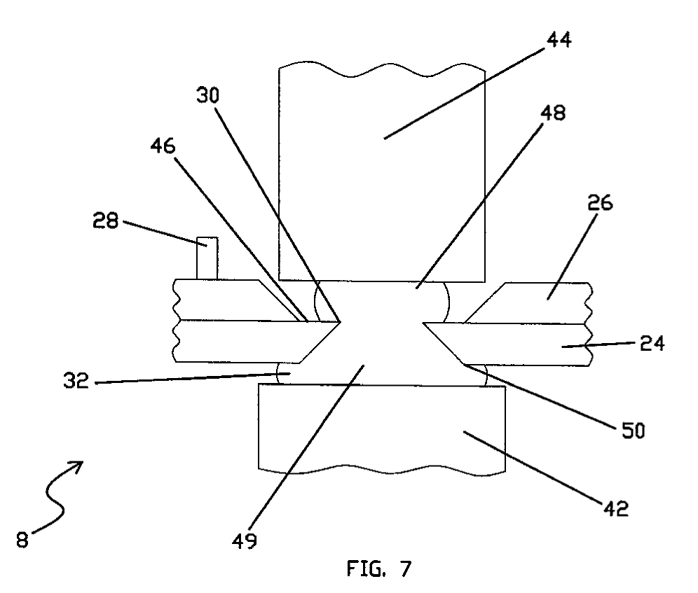

FIG. 7 shows the coining operation as performed on first mass of malleable conductive metal 32. The coining operation is achieved by using a backing pad or fixture surface 42 in conjunction with a coin punch 44. The coining step flattens first mass of malleable conductive metal 32 and fully compresses it so that the mass fills all associated cavities in through hole 30, thereby promoting an efficient, low resistant bond to the stainless steel layer 24.

The compression of first malleable mass 32 pushes the mass into and beyond the top profile edge 46 of the through hole 30 into the thickness of the stainless steel layer 24 and flattens top surface 48 of the malleable mass 32. As shown in FIG. 7, the mass of malleable conductive metal 32 may flow through the through hole 30 to the backside of the stainless steel layer 24 to form a head 49. This flow through may be enhanced by offsetting the backing pad 42 by a small gap (e.g., 0.005 to 0.050 mm) to allow lateral flow of the mass 32 beyond the bottom edge 50 of hole 30, creating an enhanced mechanical lock between the mass of metal 32 and the stainless steel layer 24. Small feet or standoff features on backing pad 42 (not shown) can promote and control the flow of the mass of metal 32 in the lateral direction beyond the edge of the hole 30. Alternatively, the backside flow of the mass of metal 32 can be restricted by the use of a flat backing pad 42, rendering the surface of mass of metal 32 flush with the surface 50 of the stainless steel layer 24.

Hole 30 can be modified in cross section geometry to improve bond retention by using sloped side walls (typically attained from the single side etching processes used in integrated lead suspensions), changing side wall angles or geometries (stepped, pointed, knife edged, etc.) or employing partial etch setback features to improve pull out force retention of the applied stud ground pad 12.

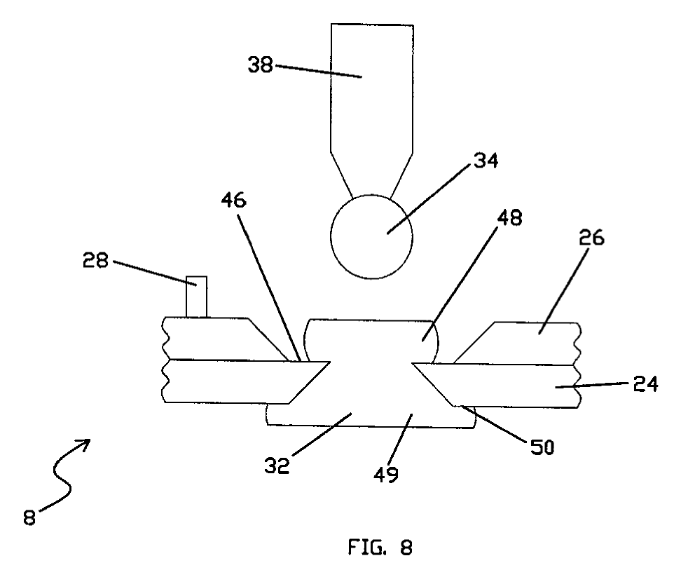

FIG. 8 shows the flexure 8 after the insertion and coining of mass of metal 32, with a second mass of malleable conductive metal 34 on the ball bonding tip 38 prior to its attachment to first mass of malleable conductive metal 32. Second mass 34 can be applied directly to the surface of the first mass 32 before mass 32 has been coined or can be applied after the first mass 32 has been coined (as is shown in FIGS. 7 and 8). Second mass 34 is applied to achieve a pad height generally equal to the height of the associated conductive trace layer 28 in preferred embodiments.

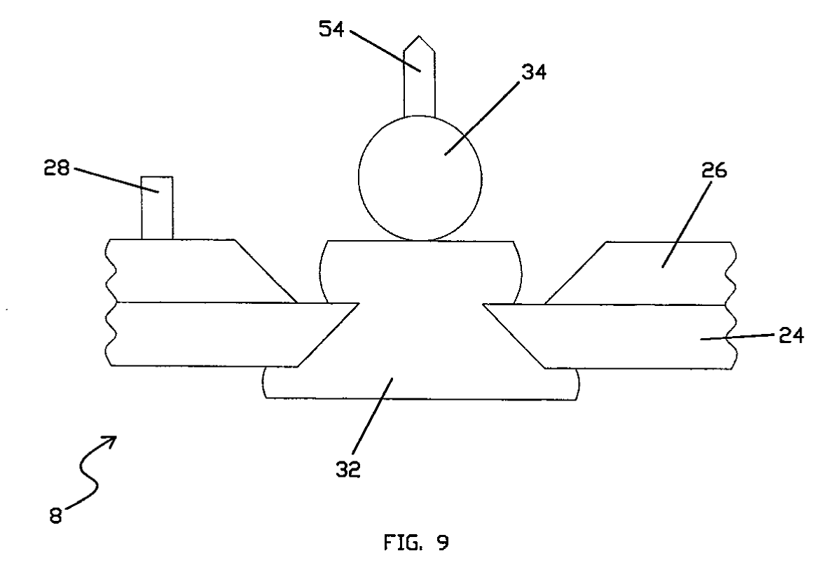

In FIG. 9, second mass of malleable conductive metal 34 is shown after it has been applied to first mass of malleable conductive metal 32. Remaining wire material tail 54 is also shown, but as previously described, ball bonding equipment that cuts off or removes the remaining wire could also be used.

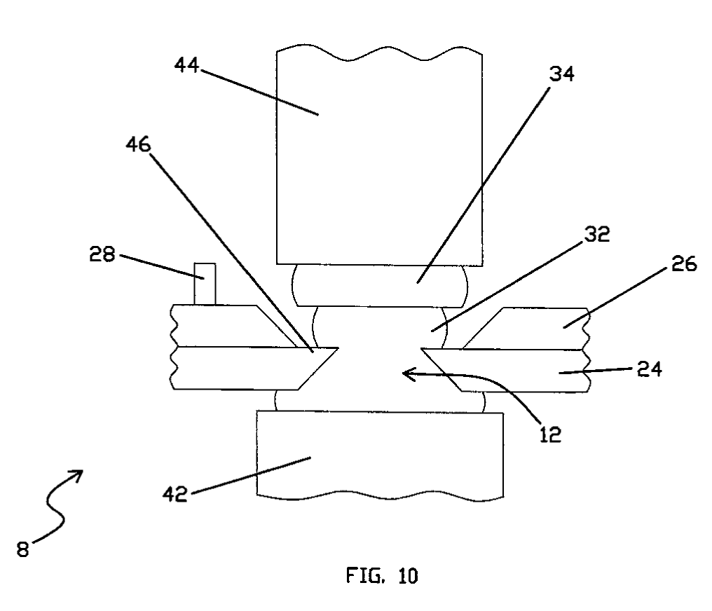

In FIG. 10, the second mass 34 is shown being subjected to the coining operation. Optionally, first and second masses 32 and 34 can be subjected to the coining operation at the same time. The resulting pad size and shape as defined by the coining operation can be attained through the natural flow of the masses of malleable conductive metal 32 and 34 beneath the coin punch 44 as defined by the stainless steel surface conditions, punch surface conditions, the coin punch compression or applied force, and the flow characteristics of the masses of malleable conductive metal 32 and 34. These attributes normally result in a circular or oval shape. If a different shape is desired, such as a rectangle or square with slightly rounded edges, the flow of the masses can be captured and shaped by applying small recess or flow restriction features (not shown) in the applied punch tip to shape and guide the flow of masses of metal 32 and 34 into the desired geometry of pad 12.

The height of stud ground pad 12 off the surface 46 of the stainless steel layer 24 can be controlled given enough flow-through has occurred beyond bottom surface 50 of stainless steel layer 24. This height can be determined by the volume of the masses of malleable conductive metal 32 and 34, mechanical spacing between the stainless steel surface 46 and the coin punch 44 using standoffs in the punch 44, or the coining forces and associated “squeeze out” or lateral flow of the masses of malleable conductive metal 32 and 34 during the coining operation. This last method will result in a consistent pad height but a slightly variable pad diameter or size.

The initial ball bond force, the ultrasonic action of the ball bonding tip 38, applied heating, and the force of any follow-on coining steps act to promote a low resistance bond between the coined ground feature 12 and the stainless steel layer 24 that may scratch-through, or otherwise defeat the typically unpredictable and nonlinear characteristics of the chromium oxide that conform on the stainless steel layer 24. Ground pad 12 can be formed and used in any region of an arm suspension assembly including the flexure gimbal region, load beam region, load beam base region, flexure tail region, and arm region. It can also be used for subsequent bonding operations by an head gimbal assembler with its own ball bond operations to join the stud ground pad with a pad on the slider, flyheight control component, or actuator motor in a typical corner joint fashion as known in the industry. The ball application and coining process can be performed on the integrated lead flexure while the flexures are still in sheet form, reducing manufacturing costs. Ground pads can also be placed beneath a metalized surface slider to allow a customer to use the enhanced conductivity of the malleable conductive metal to bond directly to applied conductive epoxy for an improved resistive performance over the chromium oxide surfaced stainless steel itself.

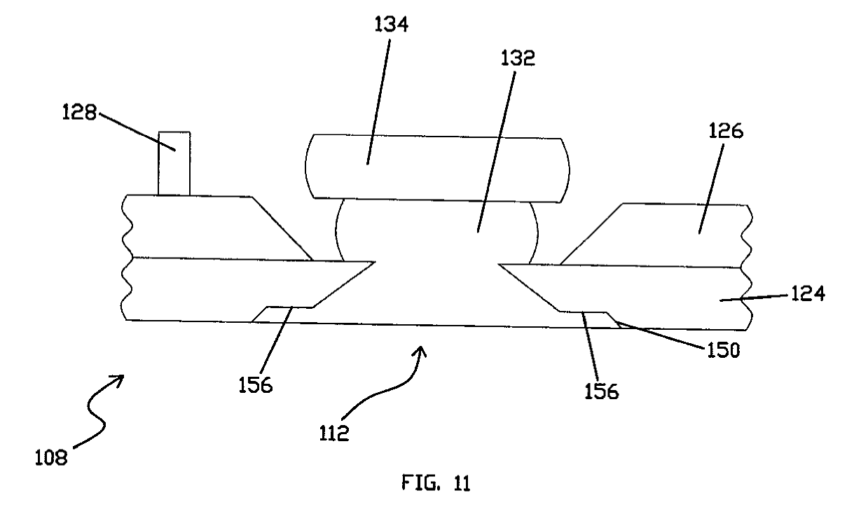

FIG. 11 shows stud ground pad 112, an alternative embodiment of the invention. Ground pad 112 is shown formed on a flexure 108. Many of the features shown in FIG. 11 are similar to those shown in FIGS. 1-10, and similar features are designated by similar reference numbers preceded by the number 100. In the embodiment shown in FIG. 11, the stainless steel layer 124 has been etched or otherwise formed on its back surface to allow the mass of malleable conductive metal 132 to flow laterally into recess 156, mechanically locking mass 132 to the stainless steel layer 124 and allowing it to remain flush with bottom surface 150 of the stainless steel layer 124.

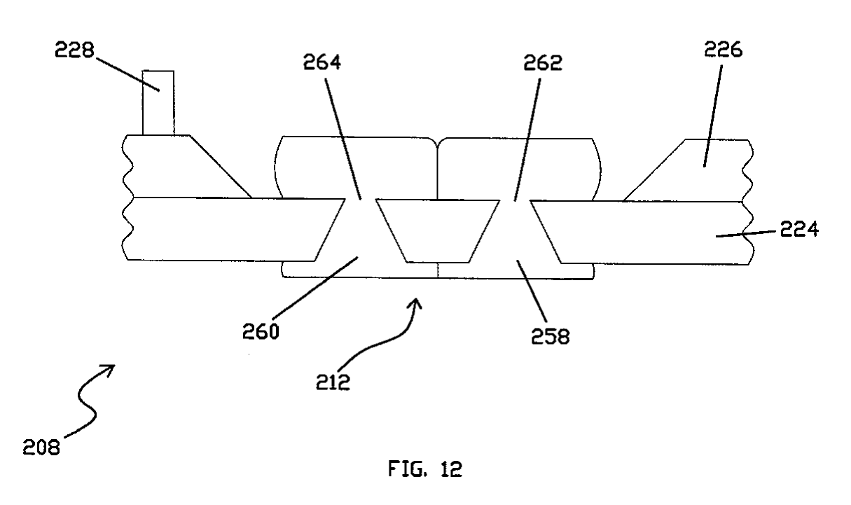

Ground pad 212 in accordance with another alternative embodiment to the stud ground pad is shown in FIG. 12. Many of the features shown in FIG. 12 are similar to those shown in FIGS. 1-10 and are designated by similar reference numbers preceded by the number 200. In the embodiment shown in FIG. 12, masses of malleable conductive metal 258 and 260 are applied to closely adjacent hole features 262 and 264, resulting in a coined ground pad 212 that is larger in diameter than could be attained by stacking multiple masses of malleable conductive metal at a single through hole.

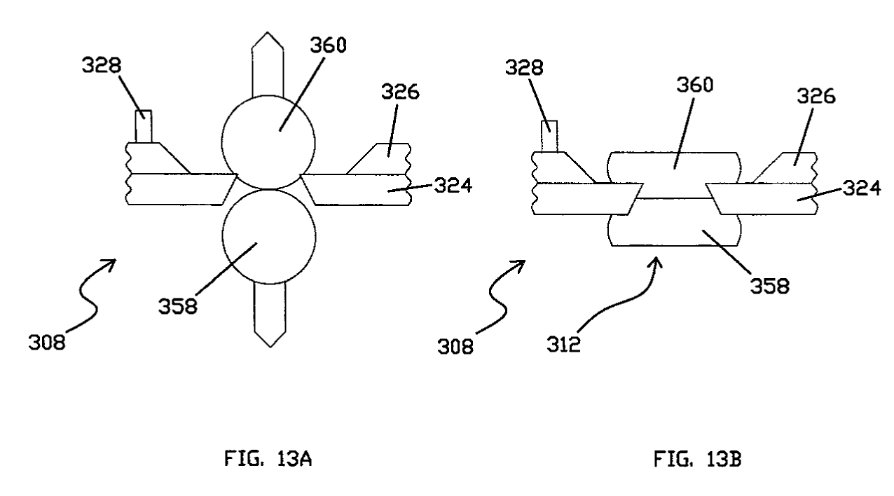

A stud ground pad 312 in accordance with yet another alternative embodiment of the invention is shown in FIGS. 13(a) and 13(b). Many of the features shown in FIGS. 13(a) and 13(b) are similar to those shown in FIGS. 1-10 and are designated by similar reference numbers preceded by the number 300. Masses of malleable conductive metal 358 and 360 are applied to both sides of the stainless steel layer 324 at through hole 330 prior to the coining process. This approach can improve the bond retention to the stainless steel layer 324.

It is sometimes desirable to form the stud ground pad in a through hole in the stainless steel layer, dielectric layer, and conductive layer of an integrated lead flexure where the dielectric and conductive layers can be laterally spaced from the through hole in the stainless steel layer or concurrent (or nearly concurrent) with the through hole in the stainless steel layer. It is also to be noted that a stud ground pad can be applied to the integrated lead flexure (either on the stainless steel side or on the conductive and dielectric layer side of the flexure) and used to ground a component mounted in the load beam or baseplate region of the head suspension, such as an amplifier chip product.

Alternatively, a sacrificial layer of gold can be applied directly to or placed beneath the stainless steel layer surface prior to coining. This allows the mass of malleable metal to adhere to the sacrificial layer through the hole in the stainless steel layer. The sacrificial layer can be removed after the mass of malleable conductive metal is coined and locked to the stainless steel layer. The sacrificial layer can be made of a sheet of dielectric material with a thin layer of sputtered gold.

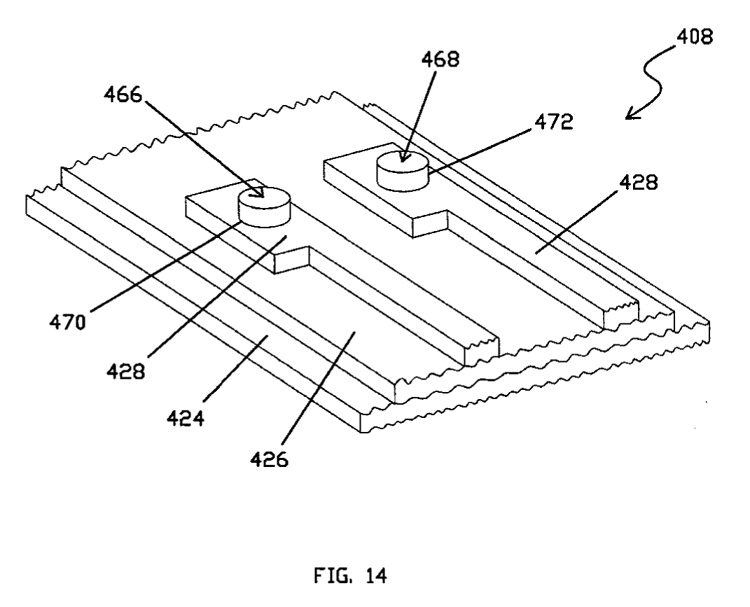

FIG. 14 is a perspective view of an embodiment of the present invention where interconnects 466 and 468 form ground connections between stainless steel layer 424 and conductive trace layer 428 of integrated lead flexure 408. Many of the features shown in FIG. 14 are similar to those shown in FIGS. 1-10 and are designated by similar reference numbers preceded by the number 400. The illustrated section of integrated lead flexure 408 is comprised of stainless steel layer 424, conductive layer 428, and dielectric layer 426 sandwiched between stainless steel layer 424 and conductive layer 428. Shown in FIG. 14 is stud ground interconnect 466 inserted in through hole 470 and stud ground 468 inserted in via 472. Through hole 470 passes through conductive layer 428, dielectric layer 426, and stainless steel layer 424. Via 472 passes through conductive layer 428 and dielectric layer 426 in this embodiment, but alternatively could pass through stainless steel layer 424 and dielectric layer 426.

The ground connection formed using this method provides relatively low resistance and can present relatively low contamination concerns. It is also cost effective and requires relatively few process steps. It can provide a ground feature that is flush with both surfaces. The hole size, laminate thickness, and laminate materials used can vary. The stud ground interconnect concept can be used with any laminate, flex circuit as is commonly known in the industry, or any other material joint in any electronics application.

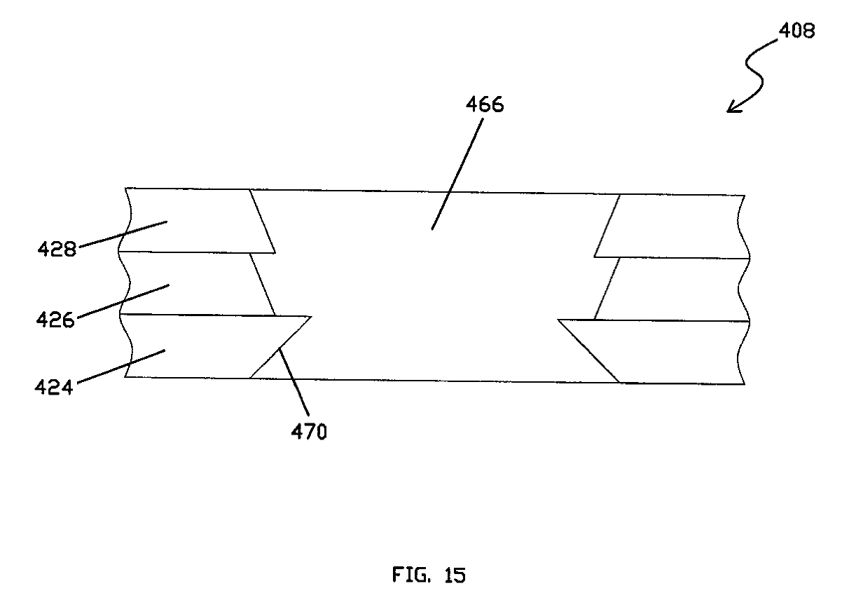

FIG. 15 is a detailed cross-sectional view of through hole 470 and coined stud ground 466 in integrated lead flexure 408. As shown in FIG. 15, coined stud ground 466 has been compressed into the thickness of stainless steel layer 424, dielectric layer 426, and conductive layer 428, forming an electrical connection between stainless steel layer 424 and conductive layer 428.

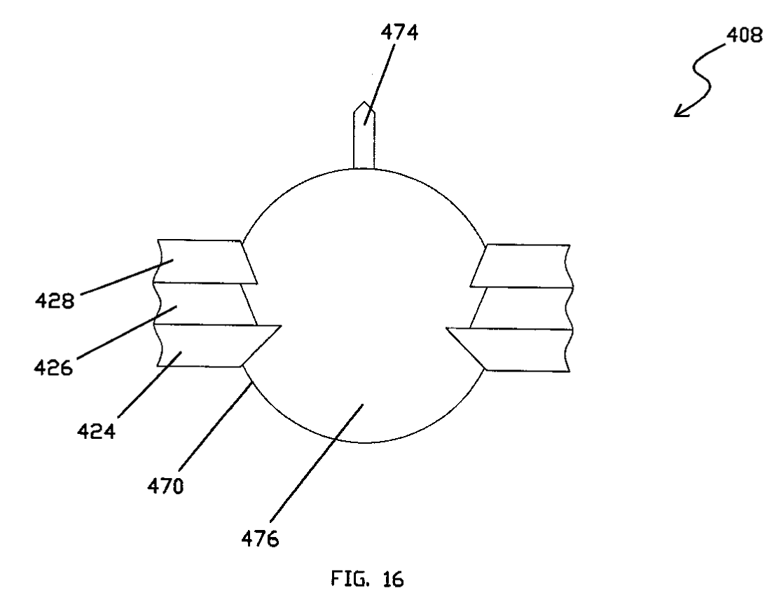

FIG. 16 is a sectional view of integrated lead flexure 408 after the insertion of mass of malleable conductive metal 476 using an ultrasonic ball bonding tip as previously described. Through hole 470 is etched or otherwise formed in stainless steel layer 424, dielectric layer 426, and conductive layer 428. Mass of malleable conductive metal 476 has been inserted so that it protrudes into conductive layer 428, dielectric layer 426, and stainless steel layer 424. Wire tip 474 is also shown or alternatively, equipment can be used that does not leave a wire tail as previously described.

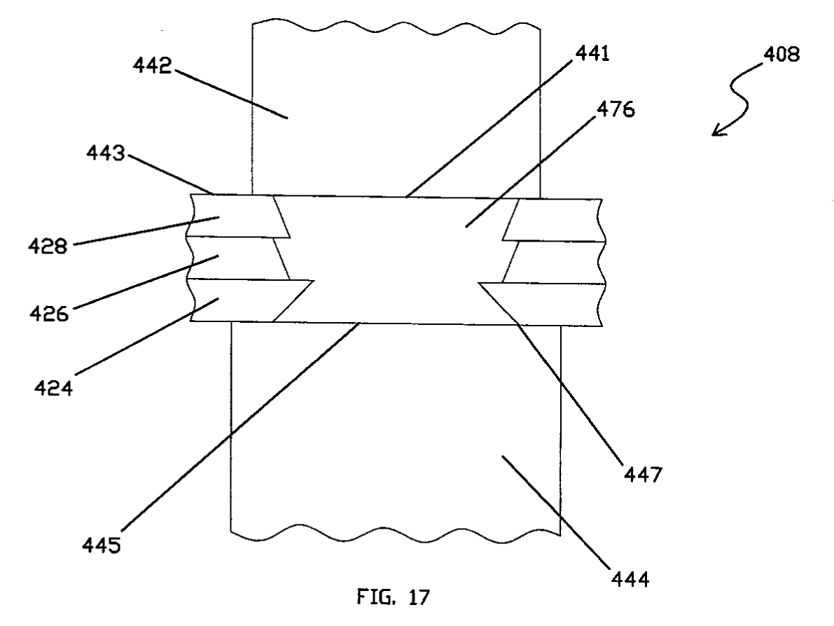

FIG. 17 shows the coining process performed on mass of malleable metal 476. The coining process compresses mass of malleable conductive metal 476 so that it fills the hole 470 in stainless steel layer 424, dielectric layer 426, and conductive layer 428, forming an electrical connection between stainless steel layer 424 and conductive layer 428. As shown in FIG. 17, top surface 441 of mass of malleable conductive metal 476 is flush with the top surface 443 of conductive layer 428 and bottom surface 445 of mass of malleable conductive metal 476 is flush with the bottom surface 447 of stainless steel layer 424 following the coining operation.

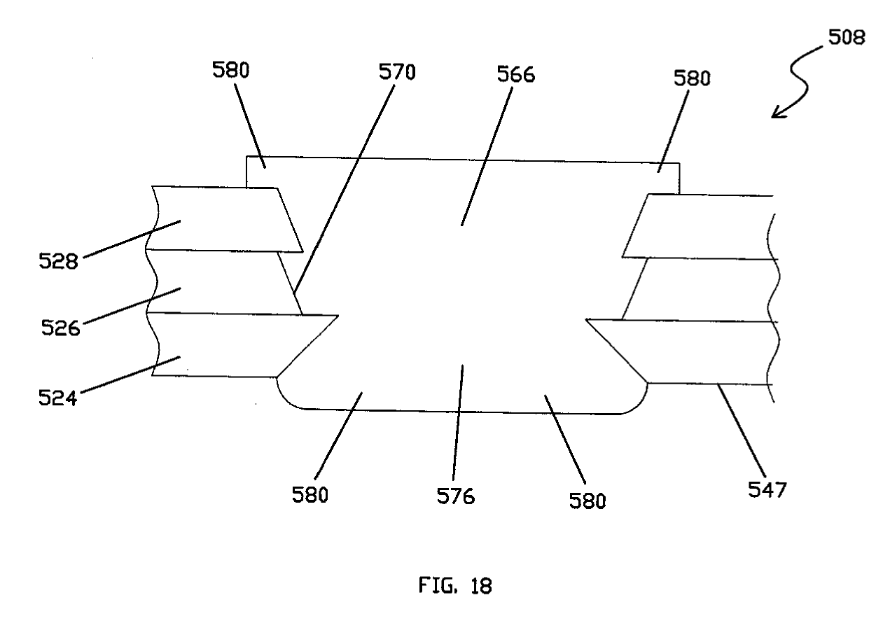

FIG. 18 is an illustration of a stud interconnect 566 in accordance with another embodiment of the invention. Many of the features of interconnect 566 shown in FIG. 18 are similar to those shown in FIGS. 14-17 and are designated by similar reference numbers preceded by the number 500. In the embodiment shown in FIG. 18, coined stud ground 566 has a head 549 with flanges 580 that are formed around through hole 570. Head 549 can provide reduced electrical resistance and improved reliability of the coined grounding stud 566. The flanges 580 can be formed using small feet or standoff features (not shown) in the coin punch to control the flow of mass 576 in the lateral direction and by offsetting the backing pad to create flanges 580 on the bottom surface 547 of stainless steel layer 524.

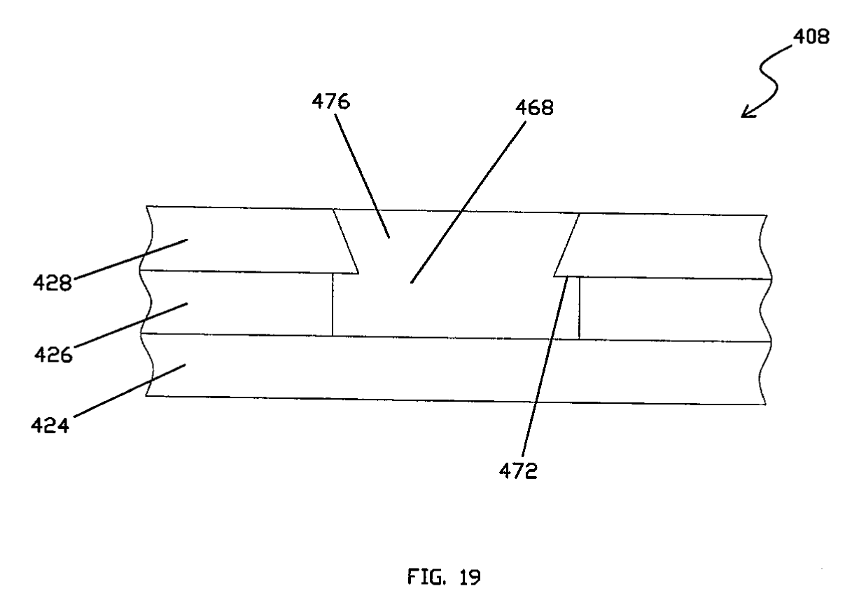

FIG. 19 is a detailed cross sectional illustration of the interconnect stud ground 468 shown in FIG. 14. Via 472 is etched or otherwise formed in conductive layer 428 and dielectric layer 426. Alternatively, via 472 could be etched or otherwise formed in stainless steel layer 424 and dielectric layer 426. Coined stud ground 468 can be formed using the process described in connection with FIGS. 14-17.

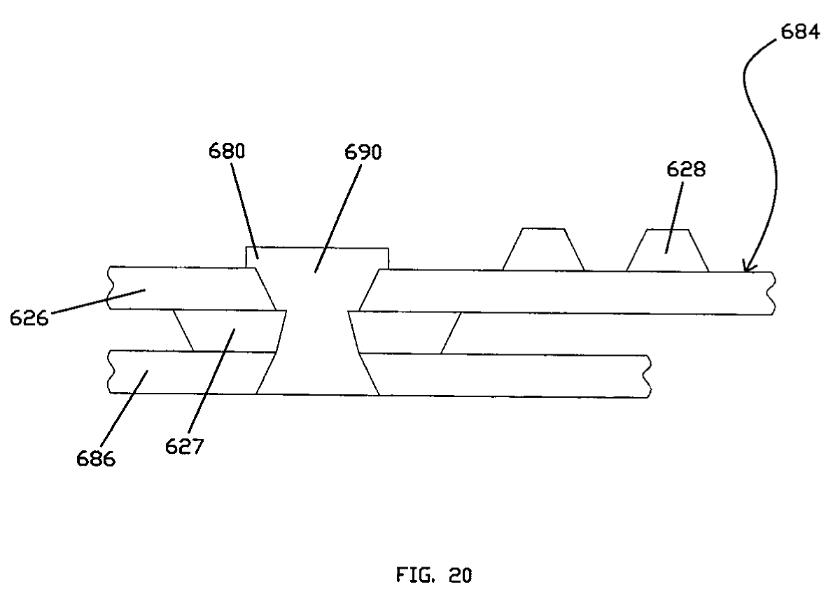

FIG. 20 is an illustration of a stud attachment 690 in accordance with another embodiment of the present invention. Many features of the embodiment shown in FIG. 20 are similar to those shown in FIGS. 1-10 and are designated by similar reference numbers preceded by the number 600. In FIG. 20, coined stud attachment 690 is used to attach a three-layer flex circuit 684 as is commonly known in the industry to suspension component 686 comprised of stainless steel or other conductive metal. Stud attachment 690 can also be used to form an electrical connection between components 684 and 686. Flanges 680 improve the retention of coined stud 690 in three-layer flex circuit 684 and are formed as described above in FIG. 18.

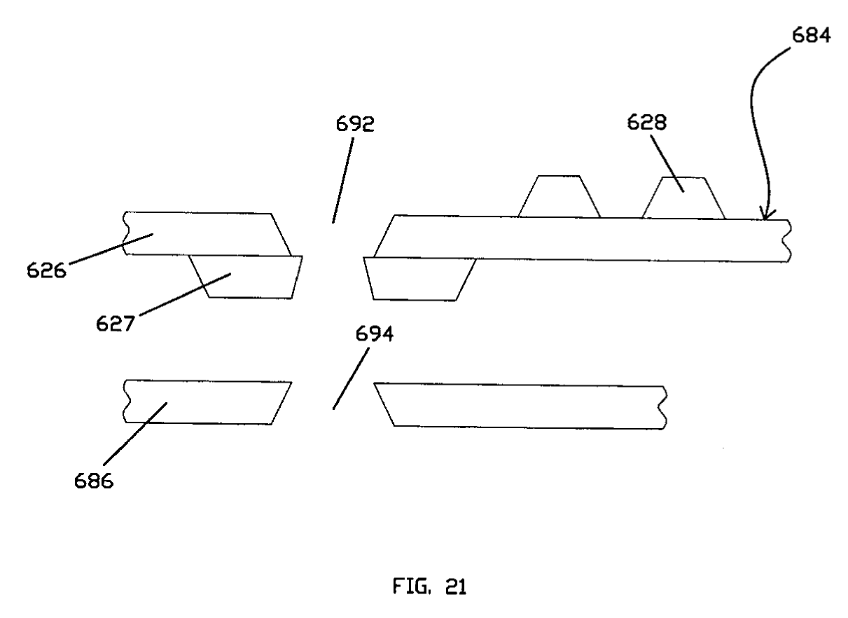

FIG. 21 shows the three layer flex circuit 684 and suspension component 686 when through holes 692 and 694 are aligned but prior to three layer flex circuit 684 being placed directly adjacent to suspension component 686. The illustrated embodiment of three-layer flex circuit 684 is comprised of conductive trace layer 628, dielectric layer 626, and shield ground layer 627. Three-layer flex circuit 684 includes etched or otherwise formed through hole 692. Suspension component 686 includes etched or otherwise formed through hole 694. As shown in FIG. 21, through hole 692 is aligned with 694 and three-layer flex circuit 684 is not yet directly adjacent to suspension component 686.

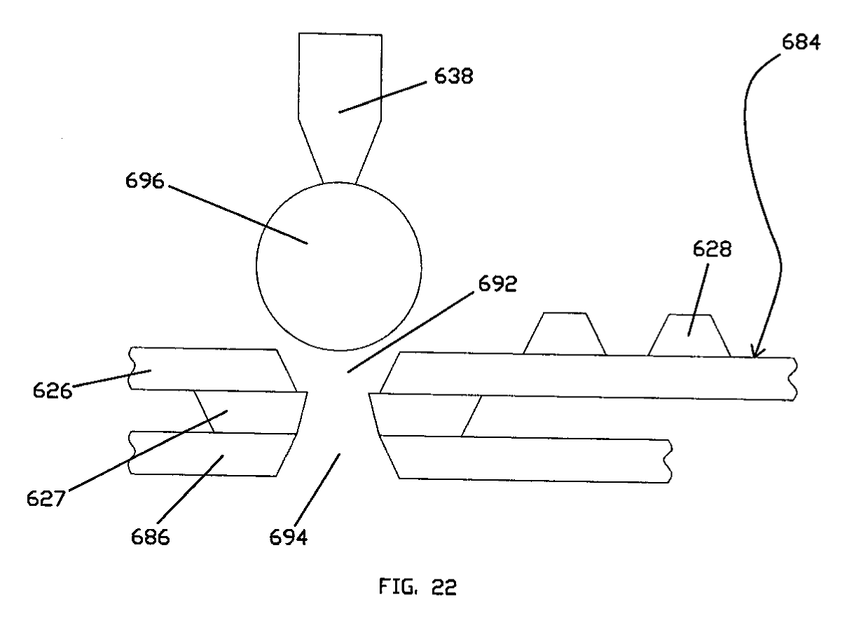

In FIG. 22, three-layer flex circuit 684 is aligned with and directly adjacent to suspension component 686. Mass of malleable conductive metal 696 is shown positioned for insertion on ultrasonic bonding tip 638 into through holes 692 and 694. The mass is inserted into through holes 692 and 694 and the coining step is then performed on mass of malleable conductive metal 696, forcing mass 696 into the through holes 692 and 694 so that mass 696 fills holes 692 and 694 creating stud attachment 690.

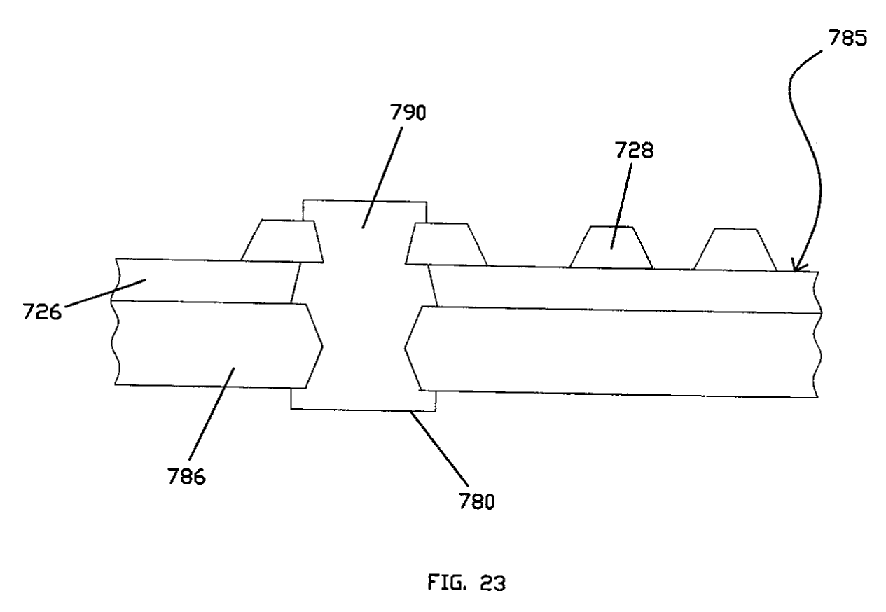

FIG. 23 illustrates a stud attachment 790 in accordance with yet another embodiment of the invention. Many of the features shown in FIG. 23 are similar to those shown in FIGS. 1-22 and are designated by similar reference numbers preceded by the number 700. In FIG. 23, stud 790 is used to attach two-layer flex circuit 785 to suspension component 786. Two-layer flex circuit 785 is comprised of conductive trace layer 728 and dielectric layer 726. As shown in FIG. 23, stud 790 fills aligned through holes 792 and 794 in two-layer flex circuit 785 and suspension component 786, respectively. Flanges 780 improve the retention of coined stud 790 in two-layer flex circuit 785.

The stud attachments of the present invention can be used to attach components of the head suspension or arm suspension assemblies together. Examples of such component attachments include flexures to load beams, stiffeners to flexures, lifters to load beams, and flexure circuits to load beams, stiffeners, or flexures. This stud attachment embodiment can also be used on FOS and FSA flex circuit interconnect products to attach dielectric or plated copper portions of the flex circuit to receptive through holes or vias etched or otherwise formed in the stainless steel load beam. The stud attachment embodiment can also be used to attach flex circuits to copper plated portions of the integrated lead suspension structure. Stud attachments can also be used to bond integrated head suspension components to arm structures. The arm structures could comprise stainless steel, aluminum, clad, polymer, or polymer with metal inserts.

The masses of malleable conductive metal can also be attached to a suspension or arm suspension structure and then shipped to a customer, possibly a head gimbal assembler or head suspension assembler, who would then perform the stud attachment process by aligning the receptive through holes or vias on the component to the mass of malleable conductive metal on the suspension and then performing the coining operation, thus locking the components together. Alternatively, the application of the masses of malleable conductive metal, the alignment step, and the coining step can all take place at the customer site using components with through holes or vias already etched or otherwise formed in them. The stud attachment bonds components together using mechanical locking or alternatively, by a gold to gold bond between a gold mass and a receptive gold surface (such as a trace or conductive layer) on a component. Flex circuits that can be used for the stud attachment embodiment can be of a single layer copper or more. The copper layers can face the suspension assembly surfaces or face away from the suspension assembly surfaces. The stud attachments can also be placed to optimize mechanical properties of the suspension assembly such as the resonance performance, the gram variation, and windage reduction.

Various modifications and additions can be made to the exemplary embodiments discussed without departing from the scope of the present invention. Accordingly, the scope of the present invention is intended to embrace all such alternative, modifications, and variations as fall within the scope of the claims, together with all equivalents thereof.

1-3. (canceled)

4. A method for forming an electrical interconnect stud to a spring metal layer in an integrated lead suspension or suspension component of the type having a multi-layer structure including the spring metal layer and a conductor layer separated by a dielectric insulator layer, the method including:
forming an aperture through the conductor and dielectric layers, at an interconnect site;
inserting a first mass of malleable conductive metal into the aperture; and
coining the mass of malleable conductive metal by compressing the metal between a pair of opposed surfaces and causing the metal to flow within the aperture, to form a stud that engages and extends between the spring metal layer and the conductor layer in the aperture at the interconnect site.

5-11. (canceled)

12. The method of claim 4 wherein:
forming the aperture further includes forming the aperture through the spring metal layer; and
coining the mass of metal includes forming an electrical interconnect stud that extends into the aperture through the spring metal layer.

13. The method of claim 4 wherein:
forming the aperture through the spring metal layer includes forming a recess in the spring metal layer on the side opposite the dielectric layer; and
coining the mass of metal includes forming an electrical interconnect stud that extends into the aperture and recess in the spring metal layer.

14. The method of claim 4 wherein forming the aperture further includes forming the aperture through the conductor and dielectric layers, but not the spring metal layer.

15. The method of claim 4 wherein coining the mass of metal includes coining the mass of metal to a height equal to a height of the conductor layer.

16. The method of claim 4 wherein coining the mass of metal further includes coining a second mass of malleable conductive metal on the first mass of conductive metal to form the electrical interconnect stud.

17. The method of claim 4 wherein coining the mass of metal includes forming a head on at least one end of the stud.

18. A method for mounting a suspension component having an aperture to a spring metal load beam, including:
etching an aperture through the spring metal load beam;
locating the suspension component adjacent to the load beam with the aperture in the component aligned with the aperture through the load beam;
inserting a first mass of malleable conductive metal into the apertures; and
coining the mass of metal to form a stud that fastens the suspension component to the spring metal load beam.

19. The method of claim 18 for mounting an integrated lead flexure having a spring metal layer to a spring metal load beam, wherein:
the method further includes etching an aperture through at least the spring metal layer of the integrated lead flexure; and
coining the mass of metal includes forming a stud that engages the spring metal layer of the integrated lead flexure and the spring metal load beam.

20. The method of claim 18 for mounting a flex circuit of the type having a dielectric insulating layer, a conductive lead layer and an aperture through at least the insulating layer to a spring metal load beam, wherein coining the mass of metal includes forming a stud that engages the dielectric insulating layer of the flex circuit and the spring metal load beam.

21. The method of claim 20 for mounting a flex circuit of the type having a dielectric insulating layer, a conductive lead layer and an aperture through the insulating and conductive lead layers to a spring metal load beam, wherein coining the mass of metal includes forming an electrical interconnect stud that engages the dielectric insulating and conductive lead layers of the flex circuit and the spring metal load beam.

22. A method for attaching first and second suspension components having apertures, including:
locating the first and second suspension components to align the apertures;
inserting a first mass of malleable conductive metal into the apertures; and
coining the mass of metal to form a stud that fastens the first and second components.
